(19) United States
(12) Patent Application Publication
(10) Pub. No.: US 2026/0221748 A1
(43) Pub. Date: Jul. 30, 2026

(54) DYNAMIC ONLINE HW-OVERCURRENT-THRESHOLD-REDUCTION DEPENDENT ON THE OPERATION POINT

(71) Applicant: VALEO EAUTOMOTIVE GERMANY GMBH, Erlangen (DE)

(72) Inventors: Andreas HELD, Erlangen (DE); Alexander RAMBETIUS, Erlangen (DE)

(73) Assignee: VALEO EAUTOMOTIVE GERMANY GMBH, Erlangen (DE)

(21) Appl. No.: 19/142,698

(22) PCT Filed: Jan. 26, 2024
(86) PCT No.: PCT/EP2024/051987

§ 371 Date: Jun. 24, 2025

(30) Foreign Application Priority Data
Jan. 27, 2023 (FR) FR2300765

(51) Int. Cl. H02H 3/00; H02H 3/08; H02H 7/08; H02H 7/122; H02M 1/00; H02M 7/5387; H02P 29/024; H02P 29/032

(52) U.S. Cl. CPC H02H 3/006; H02H 3/083; H02H 7/0833; H02H 7/1227; H02M 1/0025; H02M 7/5387; H02P 29/027; H02P 29/032

(57) ABSTRACT

A method of setting an AC overcurrent shutoff limit for an inverter of an electric motor and an inverter for an electric motor. The inverter includes power switches and output terminals for providing multiple AC currents for windings of the electric motor. A maximal allowed AC current or at least one measurement or estimation quantity based on which the maximal allowed AC current depends is determined. The overcurrent shutoff limit for the inverter is adapted in dependency of the maximal allowed AC current or the at least one measurement or estimation quantity.

The present invention generally relates to a method of setting an AC overcurrent shutoff limit and an inverter for an electric motor.

Inverters for electric motors are operated within specific parameter ranges. During switching events of the power switching devices of the inverter, a DC voltage overshoot may arise. This voltage overshoot depends on the switching speed at which the switching devices switch from a first state to a second state.

Accordingly, an overcurrent shutoff limit is considered, wherein the inverter is shut off for protection reasons if at least one of the outputted AC currents exceeds the AC overcurrent shutoff limit. In this regard, the voltage overshoot depends on the time period required for sensing the excess of the AC overcurrent shutoff limit by the actually outputted AC current and on the time period required for actually initiating and executing the shutoff procedure. Therefore, in known inverters, the AC overcurrent shutoff limit is specified such that a maximal blocking voltage of the power switches is not exceeded even considering potential voltage overshoot processes since otherwise the switching devices could be damaged. Consequently, the AC overcurrent shutoff limit is specified in a constant manner according to a worst-case scenario considering maximal nominal DC voltages of the power switches of the inverter, which are not to be exceeded under all conditions.

However, the occurring DC voltages are generally provided by means of an energy supply to the inverter, such as an energy storage device (battery). In view of aging effects, lowered battery levels, specialized operating conditions, and arising DC (leak) currents, the DC input voltage (DC link voltage) of the inverter is generally variable. In particular, it could be lowered compared to a maximal nominal DC input voltage of the inverter. The maximal allowed AC current to be outputted depends on the DC voltage of the inverter. Since for known inverters, the AC overcurrent shutoff limit is constant, the inverter, consequently, is not operated at optimum operating efficiency.

Accordingly, there is need for an overcurrent protection measure for inverters which allows the disadvantages according to the prior art to be avoided or at least to be reduced. In particular, the operating efficiency of the inverter is to be improved although the overcurrent protection measure is applied.

The subject matter of the independent claim satisfies the respective need. Preferred embodiments are indicated within the dependent claims and the following description, each of which, individually or in combination, may represent aspects of the disclosure. Some specifics of the present disclosure are described with regard to devices and others with regard to corresponding methods. However, the advantages and preferred embodiments described with regard to the indicated devices are correspondingly to be transferred to the according methods and vice versa.

A summary of certain embodiments disclosed herein is set forth below. It should be understood that these aspects are presented merely to provide a brief summary of these certain embodiments and that these aspects are not intended to limit the scope of this disclosure. This disclosure may encompass a variety of aspects that may not be set forth below.

According to an aspect, a method of setting an AC overcurrent shutoff limit for an inverter of an electric motor is provided. The inverter comprises power switches and output terminals for providing multiple AC currents to windings of the electric motor. The method comprises at least the following steps of:

A maximal allowed AC current or at least one measurement or estimation quantity based on which the maximal allowed AC current depends is determined.

The overcurrent shutoff limit for the inverter is adapted in dependency of the maximal allowed AC current or the at least one measurement or estimation quantity.

In this regard, the maximal allowed AC current may be considered a (current) value of the outputted AC current which is to be not exceeded under the present operating conditions. In contrast, the overcurrent shutoff limit may be considered to comprise a safety margin in view of the maximal allowed AC current. The safety margin is required as the detection of an outputted AC current exceeding the overcurrent shutoff limit requires a certain time period and as the actual shut off procedure of the inverter requires an additional time period. Therefore, the overcurrent shutoff limit is lower than the (current) maximal allowed AC current.

Hence, a non-constant overcurrent protection measure is provided. Therefore, the overcurrent protection measure is adapted in view of the respective operating parameters of the inverter. This allows the inverter to be operated at improved operating efficiency as the overcurrent shutoff limit may be lowered or increased in view of the actual operating conditions. This ensures that the optimum can be reached under varying conditions. In particular, when the operating parameters of the inverter are altered (such as e.g. in a short time extended output performance mode (boost mode)), the overcurrent shutoff limit may be appropriately adapted. Accordingly, it may be guaranteed that the outputted AC currents are appropriately limited by the overcurrent shutoff limit such that the arising operating parameters do not exceed intrinsic parameter limits of the inverter or its power switches or the electric motor.

Preferably, the overcurrent shutoff limit may be dynamically adapted. In this regard, the maximal allowed AC current or the at least one measurement or estimation quantity based on which the maximal allowed AC current depends may be acquired during use of the inverter. This parameter or multiple parameters may then be fed to a closed loop which sets the overcurrent shutoff limit in a dynamic fashion depending on the input quantity. Accordingly, in view of different parameters of the inverter, the overcurrent shutoff limit is always appropriately adapted according to the actual operating conditions.

Generally, the measurement or estimation quantity may be (directly) measured or rather estimated based on other parameters. According to a first alternative, the respective quantity may be a measurement quantity that was (directly) measured. According to a second alternative, the respective quantity may be an estimation quantity that was estimated based on at least one parameter, e.g. a measured parameter or a parameter gathered.

Optionally, the measurement or estimation quantity, based on which the maximal allowed AC current depends, is a DC voltage of the inverter, in particular the DC link voltage of the inverter. The voltage overshoot of the power switches directly depends on the DC voltage of the inverter. Therefore, as the power switches comprise a blocking voltage which represents a maximal allowed DC voltage between certain nodes thereof, such as between the collector and the emitter electrodes, by adapting the overcurrent shutoff limit, the operating efficiency may be improved in view of the generally variable DC voltage of the inverter.

Preferably, the DC link voltage of the inverter may be sensed by a sensor device and then provided to a control device of the inverter. Subsequently, the overcurrent shutoff limit may be adapted as described above.

In some embodiments, the overcurrent shutoff limit is constant at a first level for a first voltage range of the DC voltage. The overcurrent shutoff limit is also constant at a second level for a second voltage range of the DC voltage. In addition, the overcurrent shutoff limit varies within a transition range of the DC voltage, which is located between the first voltage range and the second range. Therefore, lower and higher DC voltage thresholds may be considered to define certain plateaus of the overcurrent shutoff limit. In between of these thresholds, a specified transition behavior of the overcurrent shutoff limit in dependency of the DC voltage of the inverter within the transition range thereof may be taken into account. Generally, the levels, e.g. the plateaus, ensure that the overcurrent shutoff limit may be kept for a certain time, e.g. variation of the measurement or estimation quantity, thereby reducing the overall computational efforts required.

Optionally, the overcurrent shutoff limit varies linearly within the transition range of the DC voltage. Accordingly, a linear dependency of the overcurrent shutoff limit from the DC voltage is established which is implementable in a simple fashion.

In an alternative, the transition range of the DC voltage may also result in a nonlinear behavior of the overcurrent shutoff limit within the transition range. Therefore, the overcurrent shutoff limit may be adapted such that the operating efficiency is optimized with respect to the DC voltage of the inverter. For instance, an exponential behavior of the overcurrent shutoff limit might be provided.

Generally, the specific behavior of the overcurrent shutoff limit within the transition range may be set according to the needs, e.g. the application scenario and/or the design of the inverter.

In some embodiments, the inverter comprises a nominal maximal allowed AC current to be outputted and a nominal overcurrent shutoff limit depending on the nominal maximal allowed AC current. Then, a ratio of an altered maximal allowed AC current divided by the nominal maximal allowed AC current may equal a ratio of the overcurrent shutoff limit adapted divided by the nominal overcurrent shutoff limit.

In this regard, the nominal maximal allowed AC current may be considered a nominal value of the outputted AC current which is to be not exceeded under all (ideal) operating conditions. The nominal overcurrent shutoff limit comprises a safety margin in view of the nominal maximal allowed AC current. Deratings or other limitations like field weakening areas may lead to the fact that the nominal maximal allowed AC current is altered, resulting in a current (altered) maximal allowed AC current. In this case, the ratio of the (altered, i.e. non-nominal) maximal allowed AC current divided by the nominal maximal allowed AC current equals the ratio of the adapted current shutoff limit divided by the nominal current shutoff limit. Hence, there are nominal values for the maximal allowed AC current and the overcurrent shutoff limit, which define a specific ratio. When adapting the overcurrent shutoff limit, the ratio may be kept constant in view of the altered maximal allowed AC current.

In an alternative, different ratios may be considered. This means that the adapted overcurrent shutoff limit may also be determined having a different dependency from the altered maximal allowed AC current compared to the ratio between the altered maximal allowed AC current divided by the nominal maximal allowed AC current.

In effect, this provides a measure to determine the adapted overcurrent shutoff limit such that the operating efficiency of the inverter is optimized.

The power switches may be configured according to a constant switching speed design. In other words, the power switches may comprise a constant gate resistor design such that the switching speed for switching from a first state to a second state, such as from a blocking state to a conducting state, is non-variable. In this case, the manufacturing expenses for the inverter and its underlying power switches are low. Generally, the voltage overshoot, which arises if the power switches are switched, at least partially depends on the switching speed at which they are switched from a first state to a second state. The higher the switching speed, the larger the voltage overshoot is. As the overcurrent shutoff limit is appropriately adapted such that the voltage overshoot of the power switches is kept below internal voltage limits (allowed blocking voltage), the overcurrent shutoff limit may be optimized in view of the constant switching speed. Thus, the inverter may be operated at optimized operating efficiency.

Alternatively or cumulatively, the measurement or estimation quantity based on which the maximal allowed AC current depends, is a temperature of the electric motor or at least one magnet thereof. In particular, the overcurrent shutoff limit is also adapted based on the temperature. The temperature of the (electro-)magnet has an influence on the maximal current allowed to be applied as otherwise demagnetizing effects may occur. Consequently, the temperature may be taking into consideration when determining the adapted overcurrent shutoff limit. Thus, demagnetizing effects may be avoided.

Of course, several measurement or estimation quantities based on which the maximal allowed AC current depends may be taken into account when adapting the overcurrent shutoff limit, such as the temperature and the DC link voltage of the inverter.

The method may be carried out in a computer-implemented fashion. In other words, the steps of the method may relate to a computer-implemented method. Thus, the inverter may comprise a data processing circuit which is utilized to adapt the overcurrent shutoff limit based on one or several input parameters or measurement or estimation quantities based on which the maximal allowed AC current depends.

According to a further aspect, there is also provided a computer program product comprising instructions which, when executed by a data processing device, cause the data processing device to execute the method as previously described.

According to another aspect, there is also provided a data storage medium comprising the computer program product as previously described such that, when executed by a data processing device, it causes the data processing device to execute the method as previously described.

According to an additional aspect, an inverter for an electric motor is provided. The inverter comprises power switches and output terminals for windings of the electric motor. The inverter also comprises a control device for controlling the operating states of the power switches. The inverter is, by means of the control device, configured to: determine a maximal allowed AC current or at least one measurement or estimation quantity based on which the maximal allowed AC current depends, and adapt an overcurrent shutoff limit for the inverter in dependency of the maximal allowed AC current or the at least one measurement or estimation quantity.

Accordingly, the advantages achieved in view of the above described method are also achieved in view of the inverter. In particular, the overcurrent shutoff limit is not constant anymore, but depends on the (current) maximal allowed AC current or the at least one measurement or estimation quantity based on which the maximal allowed AC current depends. Hence, the operating efficiency of the inverter may be improved compared to inverters having constant overcurrent shutoff limits.

In some embodiments, the control device may comprise a data processing circuit.

Optionally, the overcurrent shutoff limit is provided by at least one hardware component of the inverter. Of course, the adaption of the overcurrent shutoff limit may be carried out by means of a software algorithm. However, the overcurrent shutoff limit may then be set into a hardware component. This allows the reaction time period required for sensing an AC output current exceeding the overcurrent shutoff limit and required to perform a subsequent shutoff of the inverter to be reduced since a hardware based safety mechanism is faster than a software based routine.

In addition, the inverter is further configured to perform the method as described previously.

Preferably, the inverter may comprise at least one sensor configured to sense a DC (link) voltage of the inverter or a temperature of the electric motor or a magnet thereof or a measurement quantity which depends on the temperature of the electric motor or the magnet thereof. Also, several sensors may be provided in this regard. The acquired measurement data may then be provided to the control device such that the control device may appropriately adapt the overcurrent shutoff limit.

The temperature of the electric motor or a magnet thereof may be determined based on an estimation approach, for example by evaluating the inductance or magnet currents during operation.

All features and embodiments disclosed with respect to any aspect of the present disclosure are combinable alone or in (sub-)combination with any one of the remaining aspects of the present disclosure including each of the preferred embodiments thereof, provided the resulting combination of features is reasonable to a person skilled in the art.

The forgoing aspects and further advantages of the claimed subject matter will become more readily appreciated as the same become better understood by reference to the following detailed description when taken in conjunction with the accompanying drawings. In the drawings,

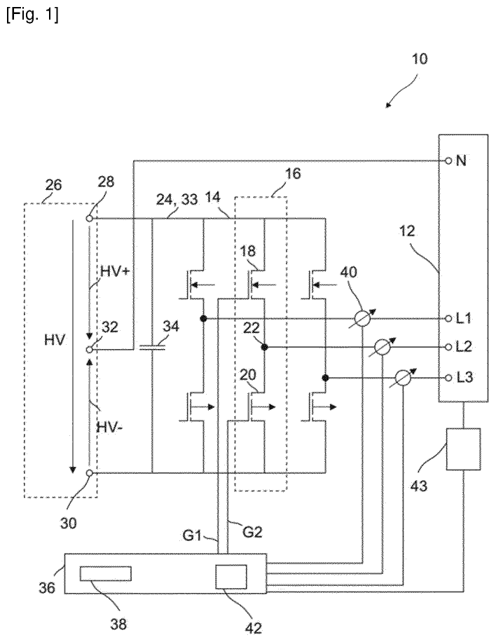

FIG. 1 is a schematic drawing of an inverter for an electric motor according to an embodiment of the invention,

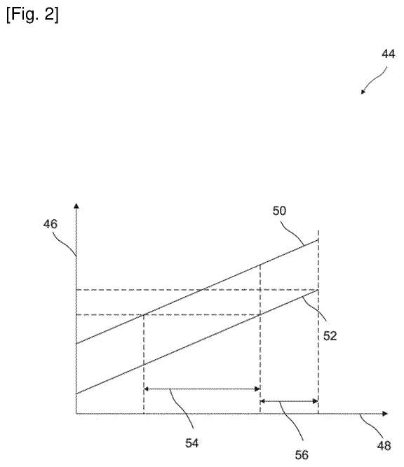

FIG. 2 is a schematic drawing of a rise of the AC current during a shutoff process delay,

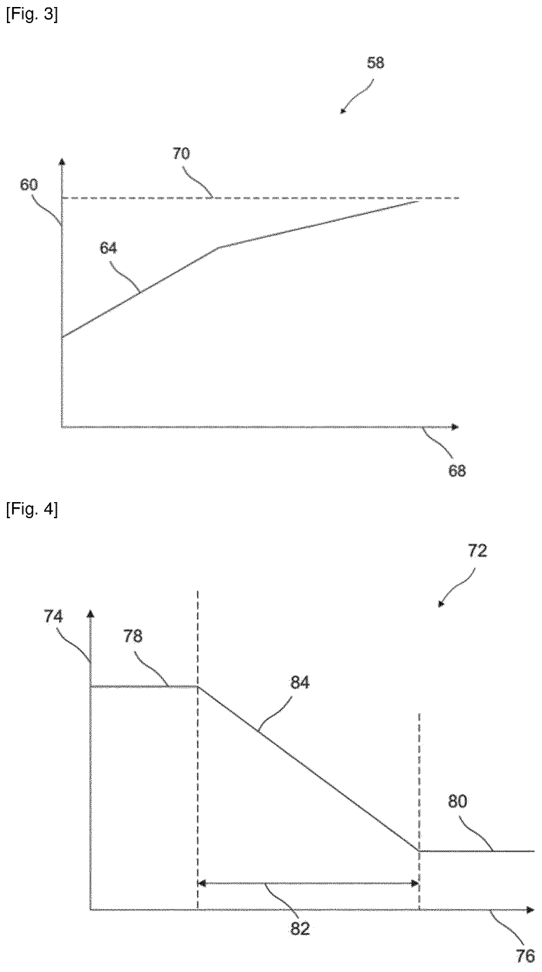

FIG. 3 is a schematic drawing of the voltage overshoot during switch-off of a power switch,

FIG. 4 is a schematic drawing of the overcurrent shutoff limit depending on the DC voltage of the inverter,

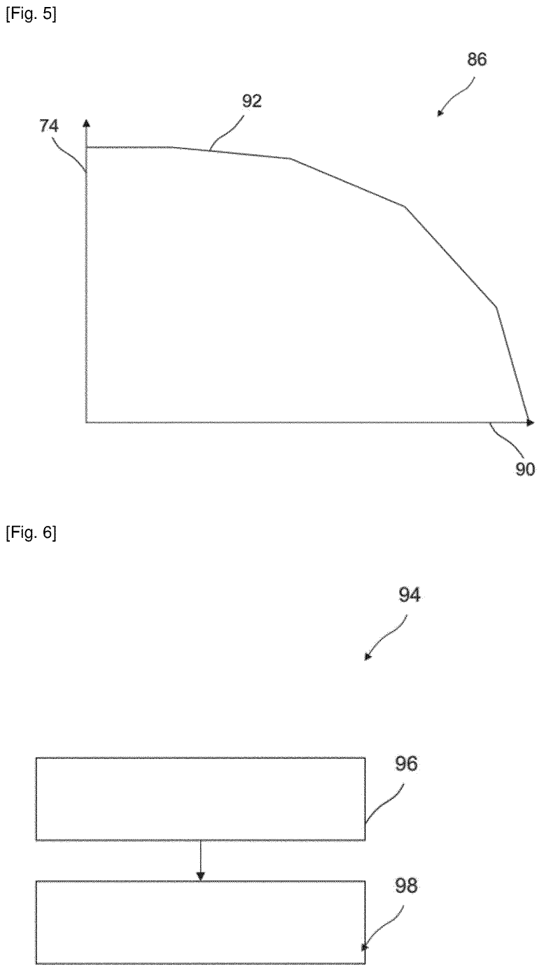

FIG. 5 is a schematic drawing of the maximal allowed AC current depending on the temperature, and

FIG. 6 is a schematic drawing of a method of setting an AC overcurrent shutoff limit for an inverter of an electric motor according to an embodiment of the invention.

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

All of the features disclosed hereinafter with respect to the example embodiments and/or the accompanying figures can alone or in any sub-combination be combined with features of the aspects of the present disclosure including features of preferred embodiments thereof, provided the resulting feature combination is reasonable to a person skilled in the art.

For the purposes of the present disclosure, the phrase “at least one of A, B, and C”, for example, means (A), (B), (C), (A and B), (A and C), (B and C), or (A, B, and C), including all further possible permutations when greater than three elements are listed. In other words, the term “at least one of A and B” generally means “A and/or B”, namely “A” alone, “B” alone or “A and B”.

FIG. 1 is a schematic drawing of an inverter 10 for a device, e.g. an electric motor 12 as shown in the embodiment.

In the shown embodiment, the inverter 10 comprises a B6-bridge 14 having three half-bridges 16. The following functionality is illustrated with respect to one half-bridge 16 only, but is to be applied accordingly to all half-bridges 16 of the B6-bridge 14.

Each half-bridge 16 comprises a first power switch 18 (field effect transistor), which acts as a high-side power switch, and a second power switch 20 (also field effect transistor), which acts as a low-side power switch. Between the first power switch 18 and the second power switch 20, each half-bridge 16 comprises a center node 22 for providing an AC signal, in this case L2, to the electric motor 12.

Three corresponding AC signals, L1, L2 and L3, are applied to the electric motor 12 through the three half-bridges 16. However, other topologies, for example a six-phase electric motor, are also possible, which then require corresponding modifications of the inverter 10.

The respective half-bridges 16 are coupled to a bus bar structure 24 of the inverter 10. The inverter 10 is coupled to a DC power source 26. The DC power source 26 includes connection terminals 28, 30 between which a high voltage HV is provided. The DC source 26 further comprises a center terminal 32 coupled to the neutral point N of the electric motor 12. In each case, a positive or negative high voltage HV+, HV− is applied between one of the terminals 28, 30 and the center terminal 32.

Consequently, between opposite nodes of the bus bar structure 24 a DC link voltage 33 is applied during operation.

In addition, the inverter 10 comprises a DC link capacitor 34 which serves as a coupling element between the DC power source 26 and the electric motor 12.

Depending on the switching positions of the power switches 18, 20, corresponding commutation cells are formed in the inverter 10 when HV+ or HV− is applied.

To prevent a high-voltage short circuit between the terminals 28, 30, both power switches 18, 20 of a half-bridge 16 must not be conducting simultaneously at any time. In other words, at least one of the power switches 18, 20 must be blocking.

To control the switching positions of the power switches 18, 20, the inverter 10 is coupled to a control device 36 comprising at least one data processing circuit 38.

The control device 36 is configured to provide corresponding gate signals G1, G2 as switching signals for the power switches 18, 20, so that based on these signals the switching positions of the power switches 18, 20 are influenced. The control device 36 is generally coupled to other components of the electric circuit, for example, the electric motor 12 or the DC power source 26. The control device 36 can then output corresponding gate signals G1, G2, for example, as a function of the relative positions of the rotor of the electric motor 12 to the stator of the electric motor 12, so that as a result the windings (magnets) of the electric motor 12 are controlled as required.

To prevent unwanted operating conditions, the inverter 10 comprises current sensors 40 which sense the AC currents actually outputted from the center nodes 22 of the half-bridges 16 of the inverter 10 to the electric motor 12. The acquired AC currents are provided to the control device 36. The control device 36 compares the acquired actually outputted AC currents to a hardware or software coded overcurrent shutoff limit 42. Preferably, the overcurrent shutoff limit 42 is hardware coded since the reaction time for the case of exceeding the overcurrent shutoff limit 42 is shortened in this case. Generally, the overcurrent shutoff limit 42 is set to a constant value except that it is adapted as will be explained in more detail below. If at least one actually outputted AC current exceeds the overcurrent shutoff limit 42, the inverter is shut down.

According to the present embodiment, the overcurrent shutoff limit 42 is adapted based on the current operating conditions as will be explained further below. For example, a temperature of the electric motor 12 may be taken into account when adapting the overcurrent shutoff limit 42. This temperature may be sensed by a temperature sensor 43 coupled to the electric motor 12.

In other embodiments, no physical temperature sensor may be required. Instead, the operating parameters of the inverter 10 and/or the electric motor 12 may be evaluated so as to indirectly determine a temperature of the electric motor 12 and its magnets based thereon. For example, the levelling of the inductance may be used in this regard.

FIG. 2 is a schematic drawing 44 of a rise of the AC current during a shutoff process delay.

On the y-axis, the amplitude 46 of the outputted AC current is depicted while on the x-axis, the time 48 is depicted.

The real outputted AC current 50 is shifted with respect to the actually measured AC current 52, e.g. measured by means of a current sensor 40. In other words, between the real outputted AC current 50 and the actually measured is a current 52 an effective time delay is present.

A first time delay 54 is caused by the sensor delay of the current sensor 40 which is used to actually detect the outputted AC current.

If one assumes that the outputted AC current is exceeding an overcurrent shutoff limit 42 and immediately subsequent to the detection of the excessing behavior the inverter 10 is shut off, the AC current applied to the electric motor 12 even rises further during a second time delay 56. The second time delay 56 represents the time period which is required to actually initiate and carry out the shutoff procedure of the inverter 10.

As the components of the electric motor 12, such as the (electro-)magnets thereof, have a maximal allowed AC current to be applied thereto, therefore, the AC current shutoff limit 42 is required to be below the maximal allowed AC current as to this explained current rise during the time delays 54, 56.

FIG. 3 is a schematic drawing 58 of the voltage overshoot during switch-off of a power switch 18, 20.

On the y-axis, the amplitude 60 of the voltage across the power switches 18, 20 is depicted while on the x-axis, the AC-current 68 is depicted.

In addition, the voltage overshoot also depends on the outputted AC current. Therefore, in case that an overcurrent shutoff limit 42 is exceeded by the actually measured outputted AC current 52, the current rise which occurs due to the time delays 54, 56 explained in view of FIG. 2 causes the voltage overshoot to be enhanced. This means that explicitly in case of exceeding the overcurrent shutoff limit 42, the voltage overshoot across the power switches 18, 20 is enlarged compared to usual switching operations of the power switches 18, 20.

Furthermore, the voltage overshoot also generally depends on the switching speed at which the power switch 18, 20 is switched. Higher switching speeds cause larger voltage overshoot to occur.

In any case, the voltage overshoot cannot be avoided completely.

Every power switch 18, 20 comprises an internal blocking voltage 70 which must not be exceeded since otherwise the respective power switch 18, 20 may get damaged. For example, in case of a transistor, the blocking voltage 70 may be considered the maximum voltage difference between the collector electrode and the emitter electrode which the transistor is able to persist. Exceeding the blocking voltage may result in a short between the collector electrode and the emitter electrode. Accordingly, in this case, transistor is damaged.

Notably, the amplitude 60 of the voltage across the power switches 18, 20 of course also depends on the DC link voltage 33 of the inverter 10. Higher DC link voltages 33 between opposite nodes of the inverter 10 cause an enhancement of the voltage rise 64 towards higher amplitudes 60.

Consequently, the safety mechanisms are required to include that the voltage overshoot must be such that the blocking voltage 70 is not exceeded. Hence, the overcurrent shutoff limit 42 needs to be appropriately set such that this condition is met. In this regard, amongst others, the time delays 54, 56, the DC link voltage 33 as well as the switching speed need to be considered.

FIG. 4 is a schematic drawing 72 of the overcurrent shutoff limit 42 depending on the DC link voltage 33 of the inverter 10, which corresponds to a measurement or estimation quantity since the DC link voltage 33 is either measured or estimated based on at least one parameter.

On the y-axis, the maximum allowed AC current 74 to be outputted to the electric motor 12 is depicted while on the x-axis, the DC link voltage 33 of the inverter 10 is depicted.

As the DC link voltage 33 influences the current rise of the outputted AC current during the time delays 54, 56, the overcurrent shutoff limit 42 comprises different levels in dependency of the DC link voltage 33. For example, a high DC link voltage 33 may be used in specialized operating conditions.

Generally, during a boost mode, a higher maximal AC current may be requested. According to known approaches, the overcurrent shutoff limit would be required to be chosen such that this specific condition is considered also which would impact the maximal overcurrent shutoff limit. In contrast, according to the present approach, the overcurrent shutoff limit 42 is adapted based on the maximal AC current. For example, the maximal overcurrent shutoff limit 42 is reduced together with the maximal allowed AC current for high DC link voltages 33. Hence, the operating performance is optimized also for short time performance modes.

Thus, in the present embodiment, the overcurrent shutoff limit 42 has a first level 78 when the DC link voltage 33 is low(er), within a first voltage range, and a second level 80 when the DC link voltage 33 is high(er), within a second voltage range. Therefore, the overcurrent shutoff limit 42 is adapted in view of the DC link voltage 33.

Between the first level 78 and the second level 80, a transition range 82 is defined. Within the transition range 82, the overcurrent shutoff limit 42 shows a linear behavior 84 in the present embodiment.

However, the behavior of the overcurrent shutoff limit 42 may also be nonlinear within the transition rage 82. Thus, the overcurrent shutoff limit 42 may be adapted according to the respective needs of the system.

FIG. 5 is a schematic drawing 86 of the maximal allowed AC current depending on the temperature.

On the y-axis, the maximum allowed AC current 74 to be outputted to the electric motor 12 is depicted, while on the x-axis, the temperature 90 of the electric motor 12 is depicted.

The temperature 90 here refers to the electric motor 12 itself or to a temperature of the magnets of the electric motor 12, i.e. the windings thereof.

As can be seen, the trend 92 clearly indicates that the maximum allowed AC current 74 drastically decreases when the temperature 90 rises. Therefore, in dependency of the temperature 90, the overcurrent shutoff limit 42 may also be appropriately determined and chosen such that the maximum allowed AC current 74 is not exceeded even considering the time delays 54, 56.

The temperature 90 may for example be sensed by means of the temperature sensor 43 coupled to the electric motor 12.

FIG. 6 is a schematic drawing of a method 94 of setting an AC overcurrent shutoff limit 42 for an inverter 10 of an electric motor 12. Optional steps are shown in dashed lines.

In step 96, a maximal allowed AC current 74 or at least one measurement or estimation quantity based on which the maximal allowed AC current 74 depends is determined. In this regard, in particular the temperature 90, the blocking voltage 70 of the power switches 18, 20, and/or the DC link voltage 33 may be considered.

In step 98, the overcurrent shutoff limit 42 for the inverter 10 is adapted in dependency of the maximal allowed AC current 74 or the at least one measurement or estimation quantity.

Consequently, according to the method 94 the overcurrent shutoff limit 42 may be chosen such that the maximum allowed AC current 74 is not exceeded under the present operating conditions of the inverter 10 and electric motor 12.

For example, the inverter 10 may usually be operated at a first the value of the DC link voltage 33 resulting in a first value of the overcurrent shutoff limit 42. However, a manufacturer may wish to consider a mode, in which the required AC power or DC power is enhanced compared to “standard” operating conditions. Then, the method 94 provides the possibility to adapt the overcurrent shutoff limit 42 to comprise a second value which is lower than the first value. Accordingly, it may be guaranteed that the current rise and the voltage overshoot may remain below the respective limits.

This provides the possibility to enhance the operating efficiency of the electric motor 12 since an optimized switching speed of the power switches 18, 20 may be chosen which fits all values of the overcurrent shutoff limit 42.

Moreover, aging effects or other circumstances may result in a different DC link voltage 33. Once these effects or rather circumstances arise, the overcurrent shutoff limit 42 is adapted accordingly, thereby increasing the overall efficiency since the overcurrent shutoff limit 42 is dynamically adapted to the actual situation.

Alternatively, the inverter 10 may also be simplified as an adaption of the switching speed is not necessarily required. The possibility to adapt the overcurrent shutoff limit 42 provides an additional degree of freedom such that adapting the switching speed is not needed to optimize the operating efficiency.

Generally, the adaption of the overcurrent shutoff limit 42 may be performed in a closed-loop manner applying the data processing circuit 38 of the control device 36.

As was explained, the maximum allowed AC current 74 actually applied generally depends on the present conditions of the inverter 10 and the electric motor 12. Therefore, also the overcurrent shutoff limit 42 is determined to meet the present properties of the inverter 10 and the electric motor 12. Generally, the inverter 10 and the electric motor 12 have also a nominal maximal allowed AC current to be applied thereto and, consequently, a nominal overcurrent shutoff limit. The nominal values may be considered values meeting an ideal case of the electric motor 12 and its inverter 10. Due to aging effects, present operating conditions, and lowered battery levels or arising DC currents, the nominal values may be inappropriate to reflect the present operating conditions of the inverter 10 and the electric motor 12. Thus, the present values of the maximum allowed AC current and the overcurrent shutoff limit 42 are different from the respective nominal values.

The adaption of the overcurrent shutoff limit 42 may be chosen such that a ratio of the present maximal allowed AC current 74 divided by the nominal maximum allowed AC current is considered. This ratio may equal the ratio of the adapted overcurrent shutoff limit 42 to the nominal overcurrent shutoff limit. Accordingly, a rather simple adaption mechanism may be implemented. Nevertheless, the adaption of the overcurrent shutoff limit 42 provides the possibility to optimize the operating efficiency of the electric motor 12 and its inverter 10.

Certain embodiments disclosed herein, particularly the respective module(s), utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about”, “approximately”, “near” etc., mean plus or minus 5% of the stated value.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

1. A method of setting an AC overcurrent shutoff limit for an inverter of an electric motor, the inverter comprising power switches and output terminals for providing multiple AC currents for windings of the electric motor, the method comprising the steps of:
a) Determining a maximal allowed AC current or at least one measurement or estimation quantity based on which the maximal allowed AC current depends, and
b) Adapting the overcurrent shutoff limit for the inverter in dependency of the maximal allowed AC current or the at least one measurement or estimation quantity.

2. The method of claim 1, wherein the measurement or estimation quantity based on which the maximal allowed AC current depends is a DC voltage of the inverter.

3. The method of claim 2, wherein the overcurrent shutoff limit is constant at a first level for a first voltage range of the DC voltage wherein the overcurrent shutoff limit is constant at a second level for a second voltage range of the DC voltage and wherein the overcurrent shutoff limit varies within a transition range of the DC voltage which is located between the first voltage range and the second voltage range.

4. The method of claim 3, wherein the overcurrent shutoff limit varies linearly within the transition range of the DC voltage.

5. The method of claim 1, wherein the inverter comprises a nominal maximal allowed AC current to be outputted and a nominal overcurrent shutoff limit depending on the nominal maximal allowed AC current, and wherein a ratio of an altered maximal allowed AC current divided by the nominal maximal allowed AC current equals a ratio of the overcurrent shutoff limit adapted divided by the nominal overcurrent shutoff limit.

6. The method of claim 1, wherein the measurement or estimation quantity based on which the maximal allowed AC current depends is a temperature of the electric motor or at least one magnet thereof.

7. An inverter for an electric motor, the inverter comprising power switches and output terminals for windings of the electric motor, wherein the inverter also comprises a control device for controlling the operating states of the power switches and wherein the control device is configured to:
a) determine a maximal allowed AC current or at least one measurement or estimation quantity based on which the maximal allowed AC current depends,
b) adapt an overcurrent shutoff limit for the inverter in dependency of the maximal allowed AC current or the at least one measurement or estimation quantity.

8. The inverter according to claim 7, wherein the overcurrent shutoff limit is provided by at least one hardware component.

9. (canceled)

10. An electric system comprising an inverter according to claim 7.

11. The method of claim 2, wherein the inverter comprises a nominal maximal allowed AC current to be outputted and a nominal overcurrent shutoff limit depending on the nominal maximal allowed AC current, and wherein a ratio of an altered maximal allowed AC current divided by the nominal maximal allowed AC current equals a ratio of the overcurrent shutoff limit adapted divided by the nominal overcurrent shutoff limit.

12. The method of claim 2, wherein the measurement or estimation quantity based on which the maximal allowed AC current depends is a temperature of the electric motor or at least one magnet thereof.

13. An electric system comprising an inverter according to claim 8.

14. The method of claim 3, wherein the inverter comprises a nominal maximal allowed AC current to be outputted and a nominal overcurrent shutoff limit depending on the nominal maximal allowed AC current, and wherein a ratio of an altered maximal allowed AC current divided by the nominal maximal allowed AC current equals a ratio of the overcurrent shutoff limit adapted divided by the nominal overcurrent shutoff limit.

15. The method of claim 3, wherein the measurement or estimation quantity based on which the maximal allowed AC current depends is a temperature of the electric motor or at least one magnet thereof.

16. The method of claim 4, wherein the inverter comprises a nominal maximal allowed AC current to be outputted and a nominal overcurrent shutoff limit depending on the nominal maximal allowed AC current, and wherein a ratio of an altered maximal allowed AC current divided by the nominal maximal allowed AC current equals a ratio of the overcurrent shutoff limit adapted divided by the nominal overcurrent shutoff limit.

17. The method of claim 4, wherein the measurement or estimation quantity based on which the maximal allowed AC current depends is a temperature of the electric motor or at least one magnet thereof.

18. The method of claim 5, wherein the measurement or estimation quantity based on which the maximal allowed AC current depends is a temperature of the electric motor or at least one magnet thereof.
